(19) United States
(12) Patent Application Publication
(10) Pub. No.: US 2012/0247394 A1
(43) Pub. Date: Oct. 4, 2012

(54) ANIMAL BEDDING AND A METHOD OF MANUFACTURING THE SAME

(76) Inventor: David Nowacek, San Antonio, TX (US)

(21) Appl. No.: 13/432,271

(22) Filed: Mar. 28, 2012

Related U.S. Application Data
(60) Provisional application No. 61/468,864, filed on Mar. 29, 2011.

(51) Int. Cl. A01K 29/00

(52) U.S. Cl. 119/171

(57) ABSTRACT

Applicant discloses an animal bedding comprising woodchips or shavings in an effective amount of aqueous potassium sorbate solution to control the growth of microorganisms harmful to animals. The woodchips or shavings may be pine, aspen, fir, birch or any other suitable woodchip and the potassium sorbate is typically in the range of about 0.5 to about 1% of the final weight of the animal bedding. A method of making the animal bedding includes the step of providing woodchips or shavings with a moisture content by weight of about 30 to about 50%. An aqueous solution of potassium sorbate is provided. The woodchips and aqueous solution are mixed and at least partially dried and then screened.

This is a utility patent application that claims the benefit of, priority from and incorporates herein by reference US Provisional Application Ser. No. 61/468,864, filed Mar. 29, 2011.

### FIELD OF THE INVENTION

Animal bedding, more particularly, animal bedding comprising woodchips or shavings and an effective amount of an aqueous potassium sorbate solution to control the growth of microorganisms harmful to animals.

### BACKGROUND OF THE INVENTION

Horses, cattle and other livestock may from time to time be kept in barns or stalls. Typically the pens or stalls in which they are kept contain a four to six inch layer of bedding material on the floor. This bedding material provides comfort to the animal by insulating the animal from the bare ground, and sanitation by acting to absorb liquid waste. Organic matter such as straw, wood chips, wood pellets, sawdust, paper/cardboard products are usually used as they are inexpensive and readily available.

The bedding material also provides convenience to the keeper by allowing the solid waste to be removed periodically using a fork-type tool. As the keeper removes the waste some bedding is also removed and must be replenished.

Unfortunately, this organic material provides an excellent breeding ground for bacteria, fungi and other undesirable microorganisms. Some of these organisms are known to be problematic for the health of the animal. As the animal stands for hours or days in the presence of these organisms, their feet and hooves are susceptible to infections and injury. Some of these fungi such as Trichoderma, Mucor, Aspergillus glaucus and Gliocadium have been found in the hooves of horses suffering from a condition known as White Line Disease. White Line Disease is a particularly disabling disease and can render an animal lame.

### SUMMARY OF THE INVENTION

An animal bedding comprising woodchips or shavings; and an effective amount of an aqueous potassium sorbate solution to control the growth of microorganisms harmful to animals, wherein the woodchips or shavings may be one or more from a group comprising: pine, aspen, fir or birch, further comprising an effective amount of coloring agents, wherein the coloring agents are water based and green; wherein the coloring agent is mixed in the range of about 1:1000 to about 1:5000 parts aqueous potassium sorbate solution to give some color to the surface of the woodchips. The amount of potassium sorbate is in the range of about 0.05 to about 1% of the final weight of the animal bedding. Most of the woodchips or shavings are in their major dimensions between about one-half to about two inches and in their minor dimensions between about less than one-thousandth inch to about one-half inch. The woodchips or shavings of the animal bedding may comprise pine and the potassium sorbate is between about 0.1 and about 0.5% potassium sorbate weight of animal bedding.

A method of making animal bedding comprises the steps of providing wood particles or shavings with a moisture percent by weight of 30 to 50%, providing an aqueous solution of potassium sorbate, mixing the woodchips and aqueous solution, at least partially drying the mix; and screening the dried mix; wherein the mixing step further includes the step of continuous mixing in a screw auger; wherein the drying step uses a rotary dryer; wherein the screening step is done through a sieve in the range of 10 mesh to 30 mesh. A step of adding a colorant, wherein the purpose of colorant to identify that the shavings have been treated, too light a coloring indicates they do not have enough effective potassium sorbate.

### BRIEF DESCRIPTION OF THE DRAWINGS

FIG. 1 is a woodchip illustrating major and minor dimensions.

FIGS. 1A, 1B, and 1C illustrate a method of determining coverage of solution on woodchips after drying.

FIGS. 2A-2E illustrate, sequentially, the steps in the preparation of the animal bedding.

### OBJECTS OF THE INVENTION

It is one object of the invention to provide an animal bedding that helps prevent microorganism growth, and a method for making the same.

One aspect of the present invention is a method of treating the wood shavings or other bedding material with an aqueous solution of organic anti-fungal product. The product may then be dried to a required moisture content (typically less than 20%) during or prior to packaging (or loading, if in bulk) so the bedding material becomes “medicated” and will not readily support the growth of these microorganisms.

The antifungal product(s) are:

1.) A Bordeaux mixture of copper sulfate, lime and water. Bordeaux mixture can be prepared using differing proportions of the components. In preparing Bordeaux mixture, the copper sulfate and the lime are dissolved separately in water and then mixed together. Calcium oxide (burnt lime) and calcium hydroxide (hydrated lime) gives the same end result since an excess of water is used in the preparation.

The conventional method of describing the mixture's composition is to give the weight of copper sulphate, the weight of hydrated lime and the volume of water in that order. The percentage of the weight of copper sulphate to the weight of water employed determines the concentration of the mixture. Thus a 1% Bordeaux mixture, which is typical, would have the formula about 1:1:100, with the first “1” representing 1 kg copper sulphate(penta-hydrated), the second representing 1 kg hydrated lime, and the 100 representing 100 litres (100 kg) water. As copper sulphate contains 25% copper, the copper content of an about 1% Bordeaux mixture would be about 0.25%. The quantity of lime used can be lower than that of the copper sulphate. About 1 kg copper sulphate actually requires only about 0.225 kg of chemically pure hydrated lime to precipitate all the copper. Good proprietary brands of hydrated lime are now freely available but, as even these deteriorate on storage (by absorbing carbon dioxide from the air), a ratio of less than about 2:1 is seldom used, which corresponds to a 1:0.5:100 mixture.

2.) An aqueous mixture of Copper Octanoate (copper soap) and water. Typical mixture is from 0.05% to 20% Copper Octanoate to 99.95% to 80% water. The actual ratios may vary depending on specific organisms being targeted.

3.) A Burgundy Mixture is made by combining dissolved copper sulfate and dissolved sodium carbonate. Dissolved copper sulfate ratios generally range from 1:1 to 1:18. Sodium carbonate is generally added in higher quantities and at a dissolved ratio of 1:1.5. Over time, the sodium carbonate will crystallize out of solution, and the closer the copper sulfate to sodium carbonate mixture is to 1:1 ratios, the faster this process occurs. This property is one key factor in the general discontinued usage of Burgundy Mixture, as the mixture must be mixed and used shortly before intended utilization.

### DETAILED DESCRIPTION OF PREFERRED EMBODIMENTS

Potassium sorbate is the preferred active ingredient. It is used in a preferred range of 0.1% to 0.5% by weight of animal bedding end product. Potassium sorbate has a molecular weight of 150.22 and dissolves well in water. It may be powder or granular and flows well. One source of potassium sorbate is Eastman Chemical Company. Source Eastman Chemical CAS:24634-61-5.

A coloring agent such as food coloring may be added to (for example green or blue) to identify the product as having been treated.

An additional coating of powdered Sodium Bicarbonate as a deodorizer may be added after a potassium sorbate solution has been applied to the shavings, and before or after the product has been dried.

### A. The Composition of the Animal Bedding

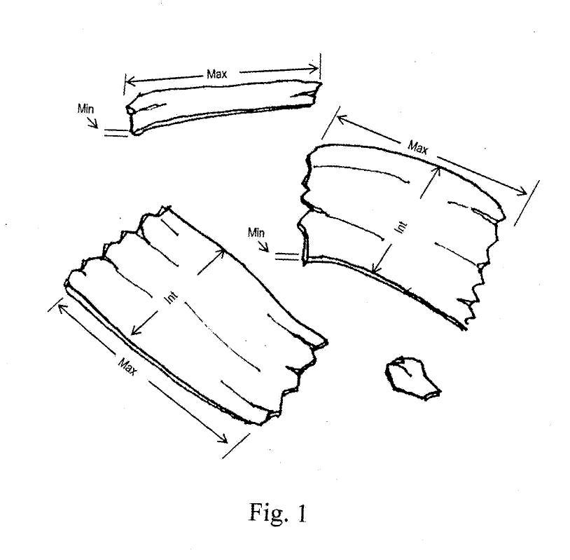

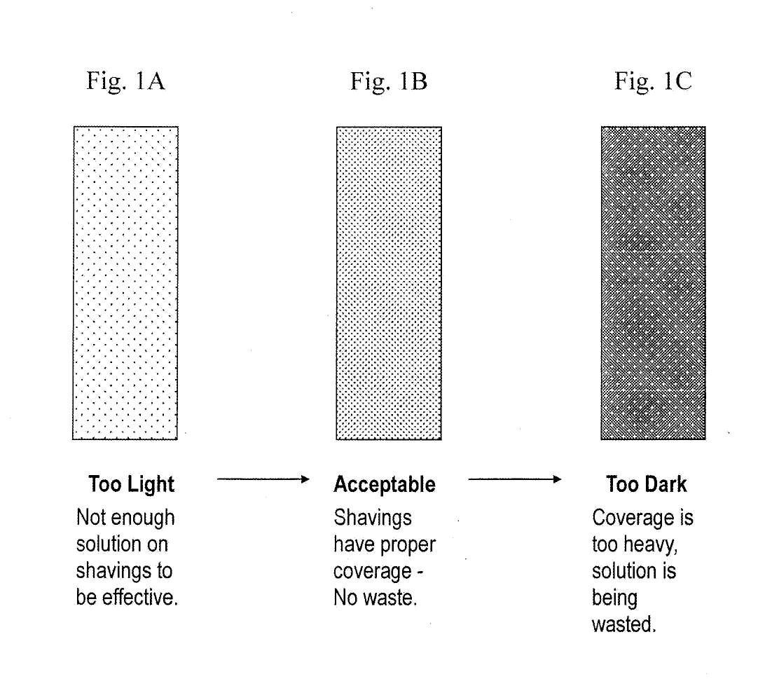

The animal bedding may comprise woodchips or shavings and may be one or more from a group comprising pine, aspen, fir or birch. The woodchips or shavings may typically have a size set forth in FIG. 1. Major axis max (typically length) is about one-half to about two inches and thickness (min) is from less than one thousandth inch up to one-half inch, typically averaging about 1/32 to ⅛ inch thick. Intermediate dimensions may be about ⅛ to ½ inch. Any suitable dimensions of woodchips may be used.

An effective amount of aqueous potassium sorbate solution may be added to the shavings in the amount of 0.05% to about 1% by weight of the treated woodchips or shavings to substantially inhibit the growth of fungi. In the preferred embodiment, the treated woodchips and shavings are substantially dry (less than 20% moisture, preferably less than about 10% moisture) and may be substantially dry pine, and the potassium sorbate is preferably between about 0.1% and about 0.5% content by weight.

A coloring agent may be added in the range of about 1 to 1000 parts to 1 to 5000 parts of the aqueous potassium sorbate solution. Amerimulch™ of Twinsburg, Ohio has a number of products that may be used as an aqueous dispersion for coloring mulch and are suitable in the present application. These include Heartland Custom Green R909, which components include water, and pigments in minor amounts of additives blended together to create a dispersion. Another suitable product is Amerimulch Forest Green R911, which includes carbon black at a concentration of less than 1% by weight. Both products are water based. Amerimulch is a low VOC (volatile organic content) or VOC3 (according to US EPA definitions) coloring containing superfine particles (between 0.1 and 1.0 micron) with extremely high density. The colorants readily mix with water or the potassium sorbate solution resulting in an even coating.

A deodorizer may be included. This application incorporates by reference U.S. Pat. No. 6,837,181 (“the '181 Patent”), entitled “Animal Litter,” and U.S. Pat. No. 5,358,738 (“the '738 Patent”), entitled “Method and Apparatus for Painting the Surfaces of Woodchips.” The composition of the deodorizer is specifically set forth in the '181 Patent and is typically sodium bicarbonate.

The '738 patent contemplates continuously conveying masses of woodchips along a lengthy path formed by a rotating, elongated, auger screw arranged within a trough-like housing. Approximately the first half of the length of the housing is covered and forms a paint application zone. The second half of the housing is open to the atmosphere and forms a paint spreading and dying zone. A paint distribution tube extends over the paint application zone and has suitable nozzles at spaced apart locations for spraying paint upon the mass of chips passing beneath them. A suitable water-based colorant or paint is spread upon the surface of the chips by a combination of the direct spray from the nozzles and by the autogenous action of the chips. That is, the chips contact and rub against each other while being tumbled and removed by the screw. That action tends to wipe or spread the paint over the exposed surfaces of the chips. The amount of colorant or paint sprayed is correlated to the amount needed to cover the surfaces of the chips without saturating the chips or substantially soaking them below their exposed surfaces. The total amount of colorant is divided into smaller parts applied, which is applied by the spray nozzles at spaced apart locations along the auger.

The '738 Patent discloses that the auger and its housing are arranged at an upwardly extending angle, from their entry towards their discharge ends. The discharge end is sufficiently high above the ground to permit the chips to fall by gravity into a pile beneath the discharge end of the conveyer outlet. Then, the chips may be removed from the pile as needed. As mentioned, the liquid colorant or paint which is sprayed upon the mass of chips in the first zone of the auger screw conveyor is spread upon the surfaces of the chips by both the direct spray and by the tumbling contacts of the chips. That autogenous spreading action continues as the chips move through the second zone of the auger screw. But, simultaneously, because housing is open over the second zone to the atmosphere, the water carrier of the colorant evaporates so that the paint dries to a substantial degree while the chips are tumbled before they are discharged from the conveyor.

The '181 Patent involves an absorbent material suitable for use as an animal litter and which is composed of a mixture of consisting of wood shavings and/or shredded wood and sodium bicarbonate. Ideally two types of wood product are used, both shredded and strands, for improved characteristics of the mixture as far as texture and absorbency.

The wood disclosed in the '181 Patent can be pine, and especially yellow pine, which has either been shaved to a particle size of about ½ inch to about 1 and ½ inches width. The two different textures of pine preferably are mixed to a ratio of approximately 50% each. The baking soda added to the mixed wood is preferably in a range of about 1% to about 6%, by weight. The wood of the new animal litter can also be partially shredded aspen with thin strands of wood fiber of about ¼ inch to about ½ inch in length. When aspen shavings are used instead of strands, the size of the particles varies to about ½ inch square. Further, mixtures of the two types of wood (mixing both aspen and pine) are acceptable, for mixing with the baking soda, in the present invention. In the '181 Patent, sodium bicarbonate is added, regardless of the wood selected, because neither aspen or pine or any type has the equivalent deodorizing character or any aroma like cedar that has a camouflaging smell. The '181 Patent discloses an absorbent deodorizing animal litter is made of the following components (all components are by weight):
1. Mix—50% yellow pine shavings with particle sizes from 1 and ½ to ¾ inches and, 50% yellow pine shredded.
2. Mix 280 pounds of the pine mixture of step 1 with 11.2 pounds of baking soda (4% ideal), or baking soda within the range of about 1% to about 10% by weight.

In the '181 Patent, an absorbent deodorizing animal litter is made of the following components (all components are by weight):

Mix about 80% shredded aspen with thin strands of wood fiber particles of from about ¼″ to about ½″ long with about 20% aspen shavings (not strands) sized from about 1/2 by ½ inch (85% of fibers retained on a 20-mesh screen). Then mix by weight about 500 pounds of the wood shreds/shavings mixture with 20 pounds of baking soda (about 4%). A range of about 5 pounds to about 50 pounds of baking soda are acceptable for this application. The aspen of the '181 patent is preferably approximately 191% absorbent. Baking soda is added specifically to aspen and to pine particles, because neither has any deodorizing smell or any other aroma, like cedar, that camouflages unpleasant odors. The mixture of two textures of pine and aspen are used for improved texture feel, and absorbency characteristics of the mixture. Although the examples describe pine mixed with pine, or aspen mixed with aspen, the mixture could also include particles of shavings of pine and particles or shavings of aspen, and so on; i.e., aspen and pine mixed, if preferred.

Applicant's effective microorganism inhibitor includes potassium sorbate in an aqueous solution typically as a powder or granule is mixed with clean or distilled water at room temperature until the potassium sorbate dissolves. Potassium sorbate has a molecular formula (C₆H₇K0₂). Chips are typically any suitable material, but may be soft wood (for example, pine) or such other wood that is presently used for horse bedding.

### B. The Process of Making the Animal Bedding

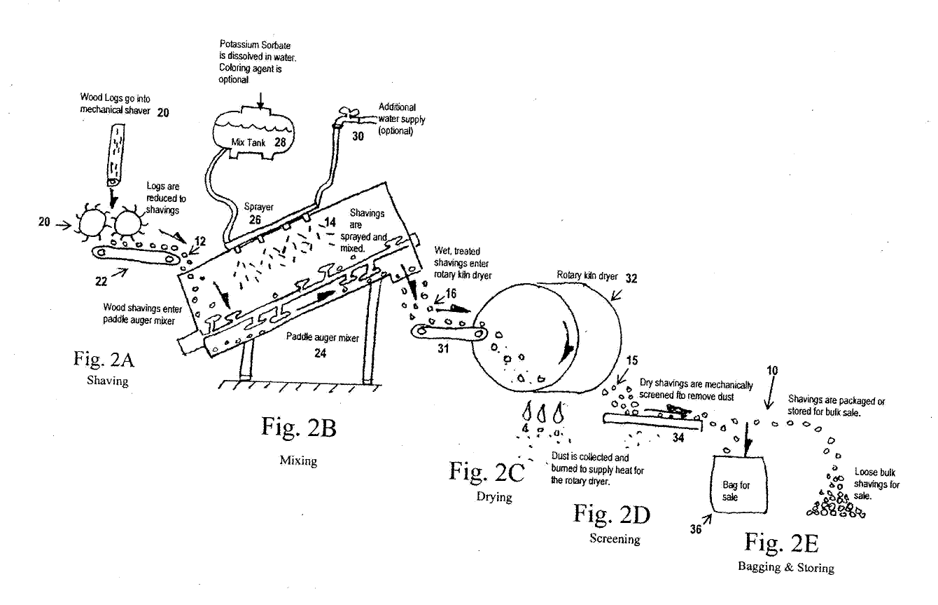

FIG. 2A illustrates the step of preparing untreated woodchips or shavings 12 from logs or other wood sources, which are typically prepared by engaging logs with a mechanical shaver or chipper 20, which may generate the chips being generally in the size set forth in FIG. 1. Alternately, woodchips may be purchased from commercial suppliers. A conveyor 22 may transport the untreated woodchips/shavings 12, which may include some dust, so they enter a screw or a paddle auger mixer 24 at FIG. 2B or other suitable mixer for the step of mixing the woodchips with an aqueous solution 14 of potassium sorbate. A sprayer 26 may be used with mix tank 28 containing potassium sorbate dissolved in water (coloring agent optional). Mix tank 28 is engaged with sprayer 26 and an (optional) diluting water supply 30 may also engage sprayer 26.

In one example, 200 gallons (about 1600 pounds) of tap water is mixed with 900 pounds of potassium sorbate until dissolved and placed in mix tank 28. Additional water 30 is provided with one part from the tank mix to 2000 parts water (may be in a range of 500 to 5000 parts water). Color is added 1 part to 2500 parts. This results in a finished product that is about 0.33% by weight potassium sorbate.

An aqueous solution 14 is provided in the concentration ranges as set forth herein or in any suitable effective concentration range. Sprayer 26 may be used with a periostolic pump type sprayer into a continuous mixing auger dimensions about 3 foot by 20 foot, for example, made by Marion Mixers, Marion, Iowa.

Screw or paddle auger mixer 24 mixes the potassium sorbate solution with the incoming shavings. Wet shavings 16 exit a removed end of the mixer. A conveyor 31 may carry wet wood shavings 16 to a rotary kiln dryer 32 or other suitable dryer for removal of moisture therefrom. Many commercial dryers are available. Moisture is removed until the shavings are dry or typically less than 20% (preferably less than 10% by weight) moisture. This can be determined typically by touch (damp or dry to touch), but may be done in other known ways. Dry treated shavings 15 exit the rotary dry kiln dryer 32 onto a sieve or screen 34 for screening dust therefrom. The result is screened treated wood shavings or chips 10 and they may be bagged 36 or collected as loose bulk shavings for sale.

The rate of spraying may be determined by the weight of the dry wood. For example, if the untreated wood 12 were 50% moist (it is typically 30-50% moist), then at 7½ tons per hour, the dry weight of the wood processed is 3¾ tons and the spraying rate will be the same as the dry wood feed rate, or about 3¾ tons of aqueous potassium sorbate 14 sprayed per hour. Resident time may be about one to three minutes, but sufficient to coat substantially all of the chips with the solution, without excess runoff.

FIGS. 1A-1C provide a guide for user to determine when a solution, mixed in the given potassium sorbate percentage range and with color added, has sufficiently coated the shavings after the drying step, when they observe the extent of coverage of solution on the shavings.

Treated chips emerge from the removed end of the mixing auger at the same rate at which they entered and are placed in a forced air (rotary) dryer (or any other suitable dryer), such as a 50 foot by 7 foot diameter commercial available rotary dryer. The treated chips are continuously fed with the resident time of about 10 to 15 minutes in the rotary dryer until they are less than approximately 20% (10% or less preferred) moisture content (typically dry to the touch).

4. Screening

The fourth step is screening for dust removal. This step is optional This is done through a continuously agitated sieve 34 of about No. 10 mesh (range 5-20) or other suitable mesh to allow the dust to be removed from the material. It is then either sold by truck load in bulk or bag.

C. Testing effective ranges of potassium sorbate

Applicant grew a wide variety of fungi (including Aspergillus glaucus; Gliocladium roseum; Mucor silvaticus; Mucor spp.; and Trichoderma viride) in petri dishes in growth mediums with various concentrations of potassium sorbate in 0.01 to 1% range. Most of the fungi tested and other microorganisms tested have been identified as a cause of White Line Disease in horses. These tests along with research showed that potassium sorbate would be an effective agent to control the growth of these fungi. Dozens of tests were done to determine the weight range or concentration of potassium sorbate effective to prevent or inhibit a material amount of growth of the pathogenic microorganisms. At below the lower end of the aqueous potassium sorbate solution; namely about 0.05%, there was a decrease in its effectiveness to prevent or inhibit material growth of these pathogenic organisms. There was no substantial inhibition of growth of the pathogenic organisms. An effective amount of potassium sorbate is the amount that will inhibit, that is which will essentially prevent material growth of these fungi during a period of about 30 days. That is to say, the effective amount in the ranges indicated is the amount which will substantially maintain the population of these microorganisms constant over a period of about 30 days.

Material was collected from animal hooves and barn stalls. This material was cultured in a laboratory and tested for the effectiveness of the solution in the various percent ranges. Fungi was grown in a growth medium and transferred to a medium with the various percentage ranges. In addition, woodchips coated in a variety of ranges were incubated in a controlled environment against woodchips without the potassium sorbate solution in an environment simulating a barn stall environment. The ranges were confirmed to be effective in inhibiting grown of the microorganisms when compared to the control.

The animal bedding of the instant disclosure may be used in horse stalls or any other suitable place. When used in a horse stall, a little bit may be added each day after the manure or soiled shavings are removed. Moreover, the bedding should be completely changed about once every 30 days.

Copper sulfate may be used in place of the potassium sorbate, and has been shown to be effective.

Although the invention has been described in connection with the preferred embodiment, it is not intended to limit the invention's particular form set forth, but on the contrary, it is intended to cover such alterations, modifications, and equivalences that may be included in the spirit and scope of the invention as defined by the appended claims.

1. An animal bedding comprising:
woodchips or shavings; and
an effective amount of an aqueous potassium sorbate solution to control the growth of microorganisms harmful to animals.

2. The animal bedding of claim 1, wherein the woodchips or shavings are one or more from a group comprising: pine, aspen, fir or birch.

3. The animal bedding of claim 1, further comprising: an effective amount of coloring agents.

4. The animal bedding of claim 3, wherein the coloring agents are water based and green.

5. The animal bedding of claim 4, wherein the coloring agent is mixed in the range of about 1:1000 to about 1:5000 parts aqueous potassium sorbate solution.

6. The animal bedding of claim 1, wherein the amount of potassium sorbate is in the range of about 0.05 to about 1% of the final weight of the animal bedding.

7. The animal bedding of claim 1, wherein most of the woodchips or shavings are in their major dimensions between about one-half to about two inches and in their minor dimensions between about less than one-thousandth inch to about one-half inch.

8. The animal bedding in claim 1, wherein the woodchips or shavings of the animal bedding comprise pine and the potassium sorbate is between about 0.1 and about 0.5% potassium sorbate weight of animal bedding.

9. A method of making animal bedding comprising the steps of:
providing substantially woodchips or shavings with a moisture percent by weight of about 30 to 50%;
providing an aqueous solution of potassium sorbate of between about 0.05% to about 1% of final weight of animal bedding;
mixing the woodchips and aqueous solution;
at least partially drying the mix to a moisture content of less than about 20%; and
screening the dried mix to remove dust.

10. The method of claim 9, wherein the mixing step further includes the step of continuous mixing in a screw auger.

11. The method of claim 9, wherein the drying step uses a rotary dryer.

12. The method of claim 9, wherein the screening step is done through a sieve in the range of 10 mesh to 30 mesh.

13. The method of claim 9, including steps of adding a colorant, wherein the purpose of colorant is to identify that the shavings have been treated properly, too light a coloring indicates they do not contain enough effective potassium sorbate.

14. An animal bedding comprising:
woodchips or shavings; and
an effective amount of an aqueous potassium sorbate solution to control the growth of microorganisms harmful to animals;
wherein the woodchips or shavings are one or more from a group comprising: pine, aspen, fir or birch. further comprising: an effective amount of coloring agents;
wherein the coloring agents are water based and green.
wherein the amount of potassium sorbate is in the range of about 0.05 to about 1.00% of the final weight of the animal bedding; and
wherein most of the woodchips or shavings are in their major dimensions between about one-half to about two inches and in their minor dimensions between about less than one-thousandth inch to about one-half inch.
